(19) United States
(12) Patent Application Publication
(10) Pub. No.: US 2025/0275500 A1
(43) Pub. Date: Sep. 4, 2025

(54) CONTROL ARM FOR LAWN MOWER CONTROLS

(71) Applicant: Ariens Company, Brillion, WI (US)

(72) Inventor: Ross M. Seefeldt, Manitowoc, WI (US)

(21) Appl. No.: 18/862,328

(22) PCT Filed: May 1, 2023
(86) PCT No.: PCT/US2023/066441

§ 371 Date: Nov. 1, 2024

Related U.S. Application Data
(60) Provisional application No. 63/337,818, filed on May 3, 2022.

(51) Int. Cl. A01D 34/82; A01D 34/66; A01D 34/68; A01D 101/00

(52) U.S. Cl. CPC A01D 34/824; A01D 34/66; A01D 2034/6843; A01D 2101/00

(57) ABSTRACT

A control arm for a lawn mower, the control arm including a lower arm having a slot defined therein, an upper arm pivotably coupled to the lower arm, the upper arm having a cam surface defining a first recess and a second recess, and a latch mechanism formed between the upper and lower arms to selectively secure the upper arm in an operational position or a stored position. The latch mechanism includes a rod supported and movable within the slot, and a biasing member configured to bias the rod into engagement with the first recess to secure the upper arm in the operational position or the second recess to secure the upper arm in the stored position.

### CROSS-REFERENCE TO RELATED APPLICATIONS

This application claims priority to U.S. Provisional Patent Application No. 63/337,818, filed on May 3, 2022, the entire contents of which are incorporated herein by reference.

### FIELD

The present invention relates to a steering mechanism for lawn mower controls.

### SUMMARY

In one aspect, the invention provides a control arm for a lawn mower. The control arm includes a lower arm having a slot defined therein, an upper arm pivotably coupled to the lower arm, the upper arm having a cam surface defining a first recess and a second recess, and a latch mechanism formed between the upper and lower arms to selectively secure the upper arm in an operational position or a stored position. The latch mechanism includes a rod supported and movable within the slot, and a biasing member configured to bias the rod into engagement with the first recess to secure the upper arm in the operational position or the second recess to secure the upper arm in the stored position.

In some aspects, the slot of the lower arm is a first slot, and the lower arm further includes a second slot that receives a pivot pin to pivotably couple the upper arm to the lower arm.

In some aspects, the lower arm includes a yoke having a first yoke arm, a second yoke arm, and a recess defined between the first and second yoke arms. A portion of the upper arm is received in the recess. In some aspects, the biasing member is a first biasing member, and the control arm further includes a second biasing member. A first sleeve is defined in the first yoke arm such that the first biasing member is received in the first sleeve of the first yoke arm. A second sleeve is defined in the second yoke arm such that the second biasing member is received in the second sleeve of the second yoke arm. In some aspects, the control arm further includes a journal bearing rotatably supported on the rod within the recess defined between the first and second yoke arms. The journal bearing is positioned between the rod and the cam surface. The journal bearing and the rod are configured to rotate relative to each other when the upper arm is moved between the operational and stored positions.

In some aspects, the upper arm further includes a first component, a second component, and an adjustable coupling that couples the first component with the second component. In some aspects, the first component includes a grip portion configured to be grasped by an operator to manipulate the control arm, and the adjustable coupling is operable to adjust the position of the grip portion relative to the operator.

In some aspects, the control arm further includes a brake cable coupled to the upper arm. The brake cable is operable to lock a ground engaging element of the lawn mower when the upper arm is in the stored position.

In some aspects, the control arm further includes a switch coupled to the lower arm, and the switch is in communication with a control unit on the lawn mower to selectively indicate to the control unit that the upper arm is in a stored position.

In another aspect, the invention provides a control arm for a lawn mower having ground engaging elements. The control arm includes a lower arm, an upper arm pivotably coupled to the lower arm, a latch mechanism formed between the upper and lower arms to selectively secure the upper arm in an operational position or a stored position, a sensor coupled to the lower arm, the sensor in communication with a control unit to selectively indicate to the control unit that the upper arm is in the stored position, an actuator coupled to the upper arm and configured to communicate with the sensor when the upper arm is in the stored position, and a brake actuation device coupled to the upper arm, the brake actuation device being operable to lock the ground engaging element when the upper arm is in the stored position.

In some aspects, the brake cable is coupled to the actuator, and the brake cable is configured to be actuated as the upper arm pivots toward the stored position.

In some aspects, the latch mechanism includes a rod supported and movable within a slot, and a biasing member configured to bias the rod into engagement with the first recess to secure the upper arm in the operational position or with the second recess to secure the upper arm in the stored position. In some aspects, the lower arm includes a yoke having a first yoke arm, a second yoke arm, and a recess defined between the first and second arms, and a portion of the upper arm is received in the yoke recess. In some aspects, the biasing member is a first biasing member, and the control arm further includes a second biasing member, a first sleeve defined in the first yoke arm, and a second sleeve defined in the second yoke arm. Each of the first biasing member and second biasing member is received in the first yoke arm and the second yoke arm.

In another aspect, the invention provides a method for assembling a control arm for a lawn mower. The method includes providing a lower arm having a sleeve and a slot that is defined orthogonal to the sleeve, inserting a biasing member into the sleeve, compressing the biasing member using a tool, inserting a rod into the slot while the biasing member is compressed, and pivotably coupling an upper arm to the lower arm after the rod has been inserted into the slot.

In some aspects, the sleeve is a first sleeve, the slot is a first slot, and the biasing member is a first biasing member, such that providing the lower arm includes providing a second sleeve and a second slot that is defined orthogonal to the second sleeve in the lower arm, and inserting the biasing member includes inserting the first biasing member into the first sleeve and inserting a second biasing member into the second sleeve.

In some aspects, compressing the biasing member within the sleeve using a tool includes inserting the tool into the slot over both the first biasing member and the second biasing member and pushing the tool against a bias of both the first biasing member and the second biasing member.

In some aspects, pivotably coupling the upper arm to the lower arm includes inserting a pivot pin through the second slot defined in the lower arm and through an aperture defined in the upper arm. In some aspects, pivotably coupling the upper arm to the lower arm includes providing the upper arm with a cam surface including a first recess, a second recess, and a protrusion extending between the first recess and the second recess, such that the method further includes releasing the compression of the biasing member such that the biasing member pushes the rod into engagement with one of the first recess and the second recess. In some aspects, inserting the rod into the slot while the biasing member is compressed includes providing a rod having a bearing mounted at a location on the rod that is configured to engage the one of the first recess and the second recess when the compression of the biasing member is released.

### BRIEF DESCRIPTION OF THE DRAWINGS

FIG. 1 is a perspective view of a lawn mower including a latch mechanism and a multi Hirth joint according to the present invention.

FIG. 2 is a perspective view of two control arms of the lawn mower, each including the latch mechanism and the multi Hirth joint.

FIG. 3 is an exploded view of one of the control arms.

FIG. 4 is an exploded view of the multi Hirth joint.

FIG. 5 is a cross-sectional view of the latch mechanism taken through the center of the control arm.

FIG. 6A is a cross-sectional view of the latch mechanism in a first position.

FIG. 6B is a cross-sectional view of the latch mechanism in a second position.

FIG. 7 is a perspective view of the latch mechanism.

FIG. 8 is a perspective view of the control arm connected to a motor of the mower.

FIG. 9 is a flow diagram of a method for assembling the control arm.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

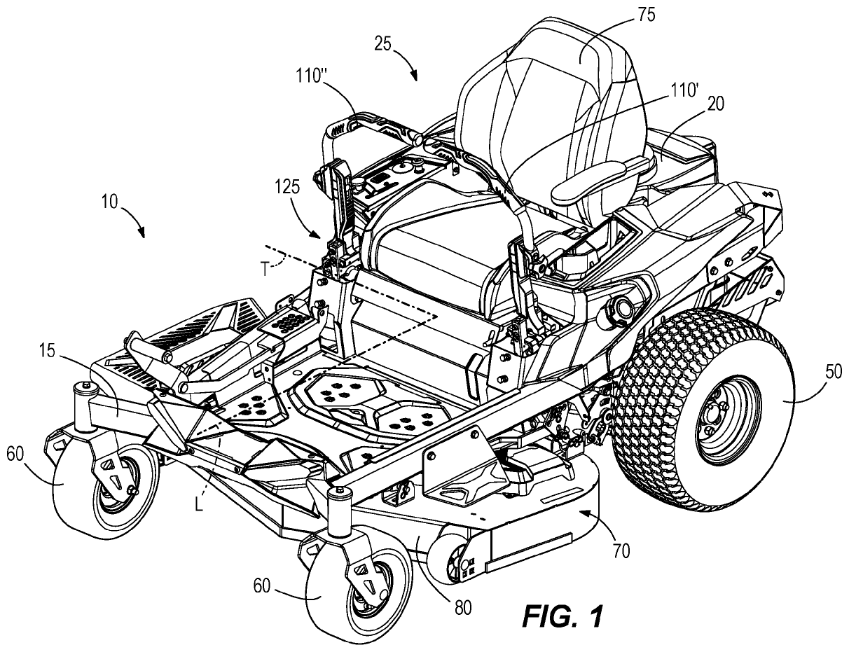

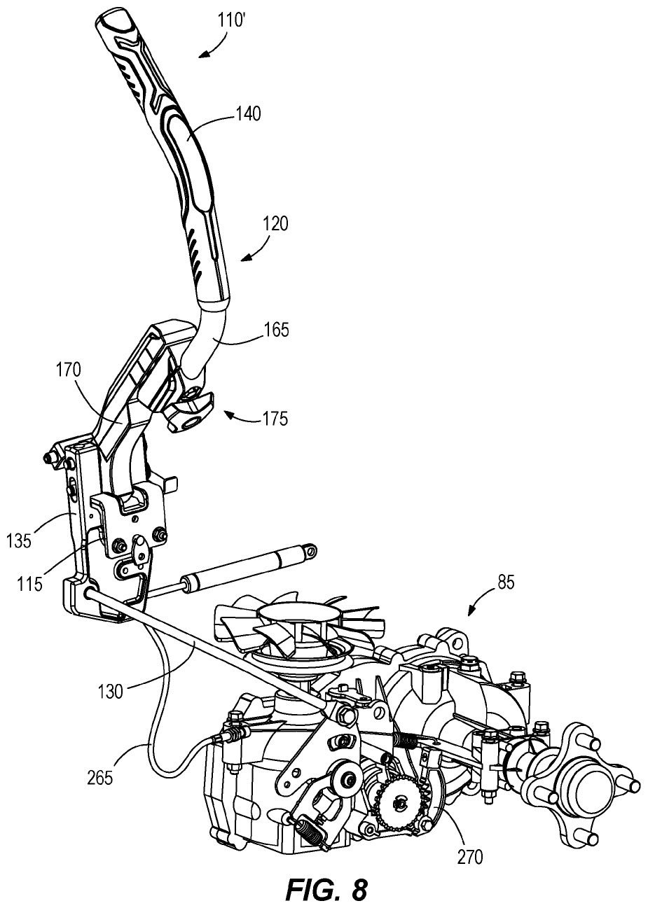

FIG. 1 illustrates a lawn mower 10 including a frame 15, a prime mover 20, an operator zone 25, drive wheels 50, casters 60, and a mower deck assembly 70. In the illustrated embodiment, the prime mover is an internal combustion engine supported by the frame 15 rearward the operator zone. In other embodiments, the prime mover 20 may be a bank of batteries in a rear storage compartment supported by the frame 15. The operator zone 25 is supported by the frame 15 forward of the prime mover 20 and includes a seat 75 for the operator and all controls within reach of the operator while seated on the seat 75. The operator zone 25 includes a left control arm 110′ and a right control arm 110″ which will be discussed in more detail below. The drive wheels 50 support a rear portion of the frame 15 and are rotated by drive motors 85 (FIG. 8) under power from the prime mover 20 and at a speed and direction dictated by position of the control arms 110′, 110″. In the illustrated embodiment, the drive motors are hydraulic transaxles. The casters 60 are passive wheels that swivel about vertical axes. The mower deck assembly 70 is suspended from the frame 15 and includes a mower deck 80 having multiple blades under the mower deck 80. In the illustrated embodiment, the blades are operably coupled to the prime mover 20. In other embodiments, the mower deck assembly 70 includes one or more electric deck motors that drive rotation of the blades beneath the mower deck 80 under power from the prime mover 20.

Other than a unique adjustable joint and the latch mechanism in the control arms 110′, 110″, the lawn mower 10 is of a type well known in the art and referred to as a zero turn radius mower. The terms left, right, forward, rearward, up and down and all other directional terms will be made from the point of view of an operator seated in the operator zone 25. The lawn mower 10 includes a longitudinal axis “L” extending forward and rearward and a transverse axis “T” extending left and right perpendicular to the longitudinal axis L. A component is said to pivot left and right, sideways, outboard and inboard, or similar if it pivots about an axis that is parallel to the longitudinal axis L. A component is said to pivot forward and back, fore and aft, or similar if it pivots about an axis that is parallel to the transverse axis T. The term “outboard” indicates a direction parallel to the transverse axis T and away from the longitudinal axis L (i.e., left and right away from the mower 10) and the term “inboard” indicates an opposite direction (i.e., toward the longitudinal axis L from one of the sides).

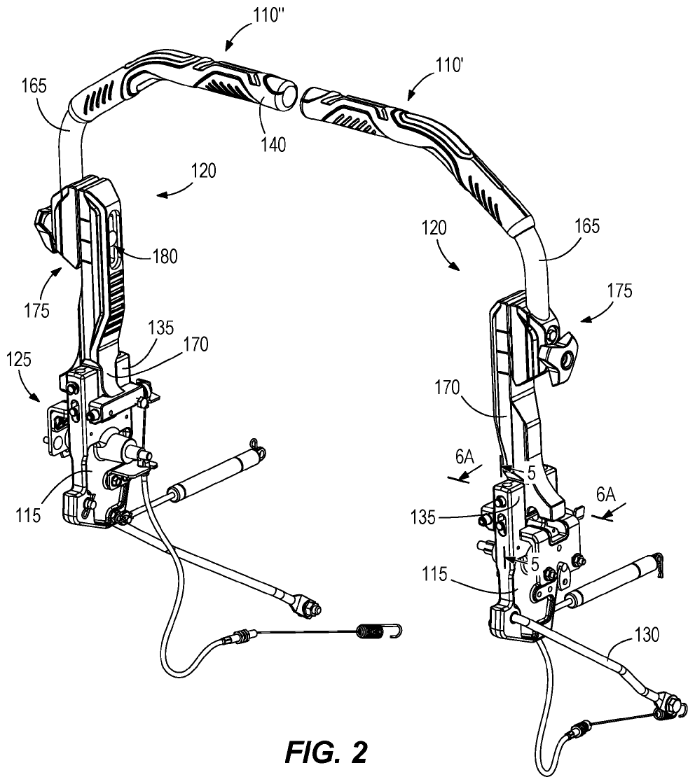

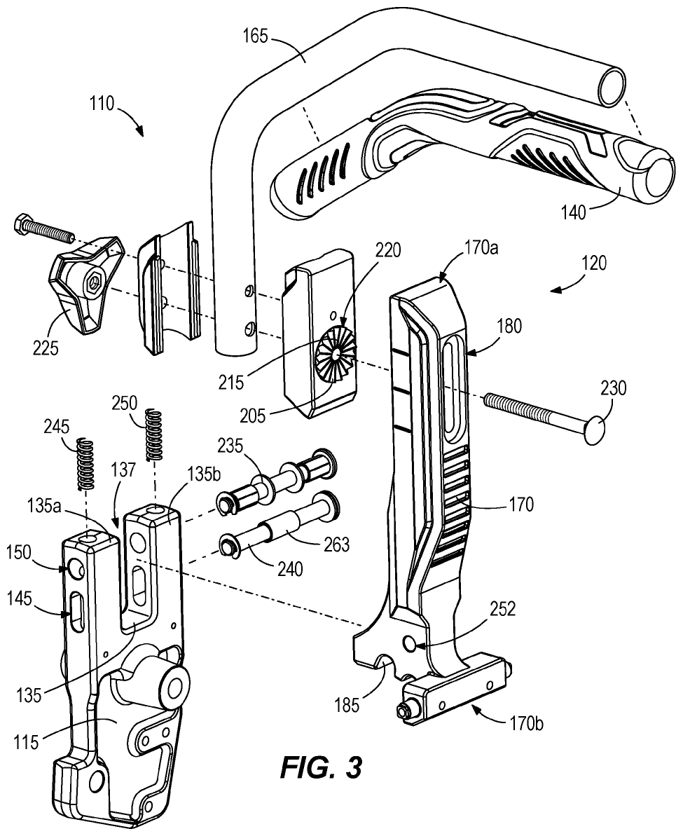

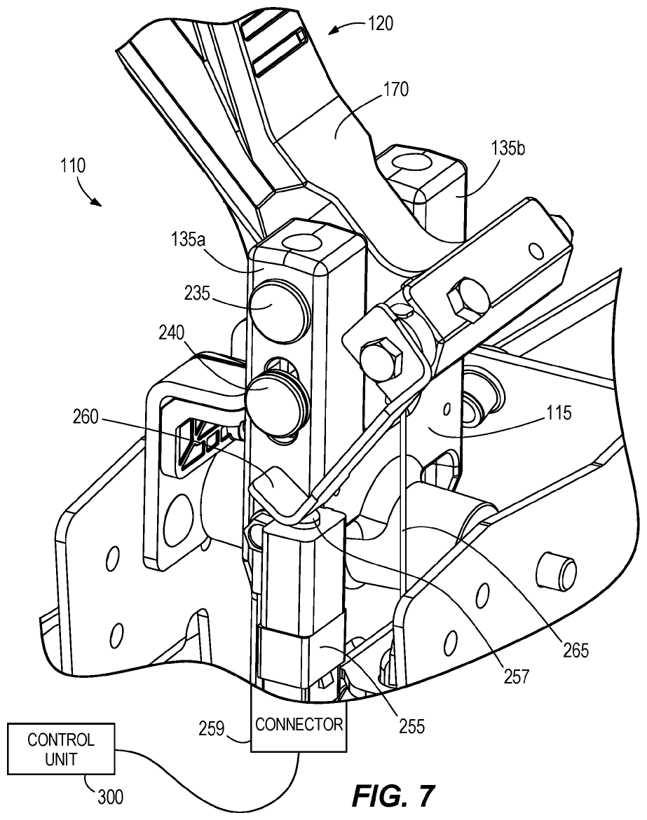

Turning to FIGS. 2 and 3, the left and right control arms 110′, 110″ are mirror images of each other and will be described together with reference to a control arm 110 (FIG. 3) unless there is a need to distinguish them from each other. The control arm 110 includes a lower arm 115, an upper arm 120, and a latch mechanism 125 connecting the lower arm 115 and upper arm 120. In the illustrated embodiment, the lower arm 115 pivots fore and aft and includes a linkage 130 to an associated hydraulic pump or transmission that operates an associated drive wheel 50. In other embodiments, the lower arm 115 may include a position sensor that provides an input to a control unit 300 (FIG. 7) to control the speed of the associated drive wheel 50 (e.g., drive by wire steering control). The upper end of the lower arm 115 includes a yoke 135 that defines a first yoke arm 135a, a second yoke arm 135b, and a recess 137 defined therebetween. The upper arm 120 includes a grip 140 that is grasped by the operator to manipulate the control arm 110.

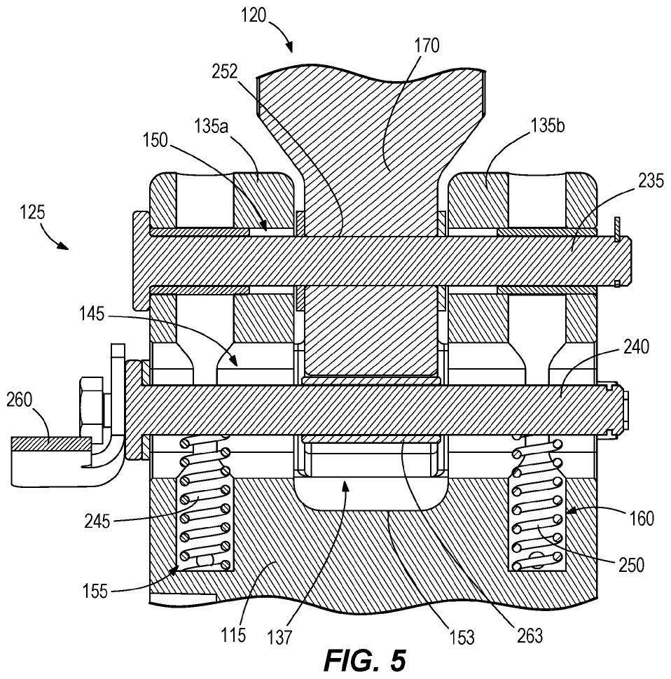

As illustrated in FIG. 5, the lower arm 115 further includes a first elongated slot 145, a second elongated slot 150, a first blind bore or sleeve 155, and a second blind bore or sleeve 160. The first slot 145 is positioned between the frame 15 (FIG. 1) and the upper end of the lower arm 115. The second slot 150 is positioned between the first slot 145 and the upper end of the lower arm 115. The first slot 145 and the second slot 150 each extend through the yoke arms 135a, 135b of the lower arm 115 in a direction parallel to the longitudinal axis L (FIG. 1).

The first sleeve 155 is defined at least partially in a first yoke arm 135a. The second sleeve 160 is defined at least partially in a second yoke arm 135b. Each of the first sleeve 155 and the second sleeve 160 extends (i.e., has a longitudinal axis extending) in a direction orthogonal (e.g., perpendicular) to both the transverse axis T (FIG. 1) and the longitudinal axis L (FIG. 1). Therefore, the first sleeve 155 extends through, or intersects, the first slot 145 and the second slot 150 in the first yoke arm 135a. The second sleeve 160 extends through, or intersects, the first slot 145 and the second slot 150 in the second yoke arm 135b. Further, the first and second sleeves 155, 160 are equally spaced on opposing sides of the recess 137 (e.g., the center of the lower arm 115) defined by the yoke 135.

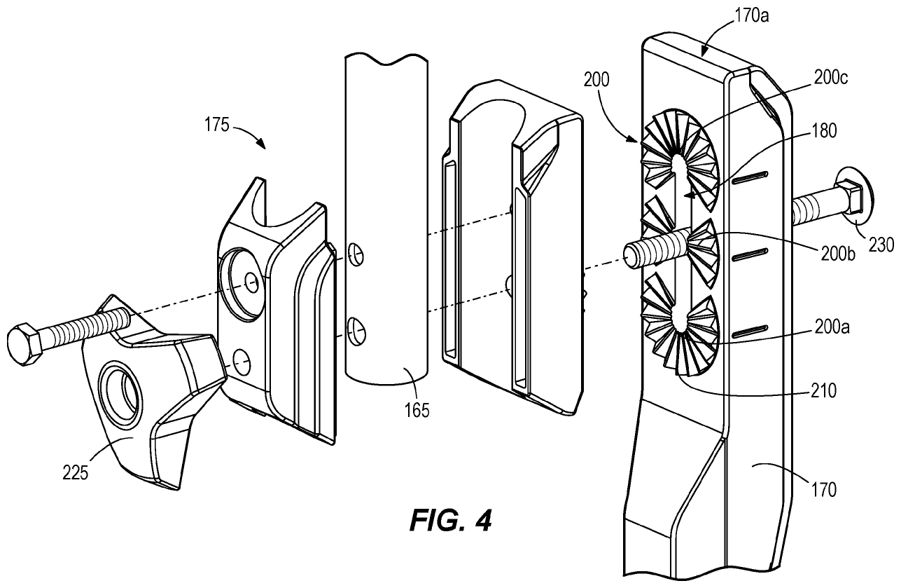

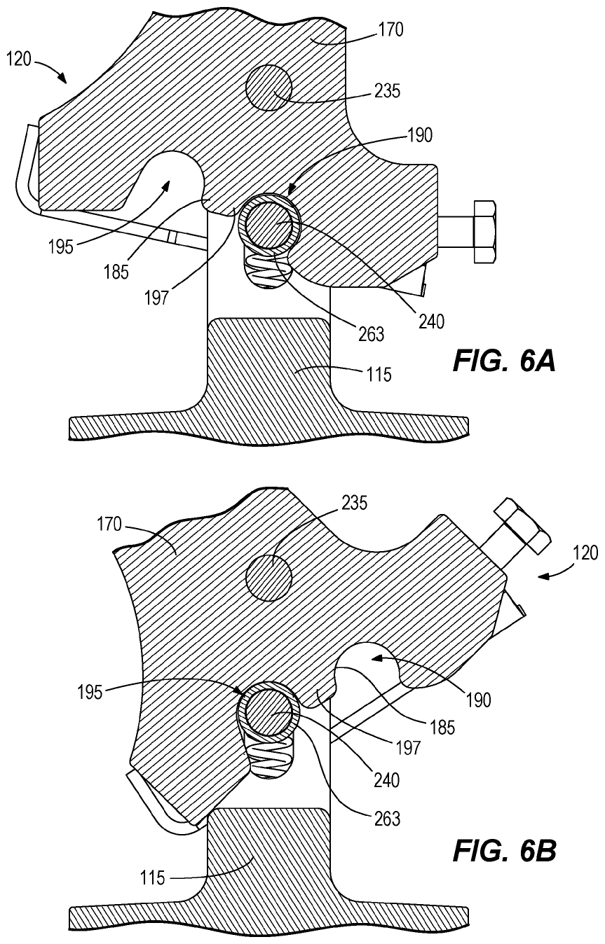

Referring to FIGS. 3 and 4, the upper arm 120 further includes a first component 165, a second component 170, and an adjustable coupling mechanism 175 connecting the first component 165 and the second component 170. The first component 165 includes the grip 140 that is grasped by the operator to manipulate the control arm 110. The second component 170 includes an adjustment slot 180 positioned at a first end 170a of the second component 170 and a cam surface 185 positioned at a second end 170b of the second component 170. The adjustment slot 180 receives the adjustable coupling mechanism 175 to couple the first component 165 to the second component 170. The adjustable coupling mechanism 175 may be adjusted along a length of the adjustment slot 180 to adjust a height of the first component 165 relative to the second component 170. As such, the adjustment slot 180 enables adjustment of the height of the grip 140 relative to the seat 75 (FIG. 1) to accommodate operators of different heights. As best illustrated in FIGS. 6A and 6B, the cam surface 185 includes a first recess 190, a second recess 195, and a protrusion 197 defined between the first and second recesses 190, 195 and at least partially separating the first recess 190 and the second recess 195.

Returning reference to FIGS. 3 and 4, the adjustable coupling mechanism 175 includes a multiple Hirth interface 200 positioned on the second component 170 and a single Hirth interface 205 positioned on the first component 165. The multiple Hirth interface 200 includes a lower Hirth interface 200a, a middle Hirth interface 200b, and an upper Hirth interface 200c. Each of the lower, middle, and upper Hirth interfaces 200a, 200b, 200c includes face teeth 210 arranged in a partial circular pattern in a face or side surface of the multiple Hirth interface 200. The adjustment slot 180 is arranged on the multiple Hirth interface 200. Specifically, the adjustment slot 180 extends diametrically through the middle Hirth interface 200b and has opposite ends centered in the lower Hirth interface 200a and upper Hirth interface 200c.

The single Hirth interface 205 has a circular pattern of face teeth 215 arranged in a circular pattern in a face or side surface of the circular Hirth interface 205. The face teeth 215 are sized and shaped to mesh or mate with the face teeth 210 of the lower, middle, and upper Hirth interfaces 200a, 200b, 200c. The single Hirth interface 205 includes a through-hole 220 centered in the circular pattern of face teeth 215. When properly assembled, the single Hirth interface 205 confronts the multiple Hirth interface 200 so the respective face teeth 210, 215 can mate in multiple discrete angular positions about the transverse axis T. As such, the single Hirth interface 205 and the multiple Hirth interface 200 further enable angular adjustment of the grip 140 relative to the seat 75 (FIG. 1) to accommodate operators with different arm lengths. The adjustable coupling mechanism 175 further includes a knob 225 and a coupling rod 230. The coupling rod 230 may be inserted through the adjustment slot 180 and the through-hole 220 to set a position of the first component 165 relative to the second component 170. The knob 225 may be tightened to secure the position of the first component 165 relative to the second component 170.

Now with reference to FIG. 5, the latch mechanism 125 includes a pivot pin 235, a rod 240, a first biasing member 245, a second biasing member 250, and a sleeve or journal bearing 263 rotatably supported on the rod 240. The second component 170 of the upper arm 120 is inserted within the recess 137 defined between the yoke arms 135a, 135b so that the cam surface 185 is disposed within the recess 137 facing the bottom of the recess 137. The second component 170 is coupled to the lower arm 115 by the pivot pin 235. In the illustrated embodiment, the pivot pin 235 is received in the second slot 150 of the lower arm 115 and an aperture 252 (as best illustrated in FIG. 3) that extends through the upper arm 120 to pivotally couple the upper arm 120 to the lower arm 115.

The rod 240 is received in the first elongated slot 145 of the lower arm 115. The first biasing member 245 is received in the first sleeve 155 of the lower arm 115. The second biasing member 250 is received in the second sleeve 160 of the lower arm 115. As such, the first biasing member 245 and the second biasing member 250 may engage the rod 240 to bias the rod 240 toward the upper end of the lower arm 115 and into engagement with the cam surface 185 (as best illustrated in FIG. 3) defined in the upper arm 120. The journal bearing 263 is rotatably supported on the rod 240 in the recess 137 defined between the yoke arms 135a, 135b. The journal bearing 263 and the rod 240 may rotate relative to each other as the journal bearing 263 engages the cam surface 185, which allows for a smoother rolling action and reduces wear on the cam surface 185 as the upper arm 120 moves relative to the lower arm 115.

As illustrated in FIG. 7, the control arm 110 further includes a sensor 255 coupled to the lower arm 115, an actuator 260 coupled to the second component 170 of the upper arm 120 (FIG. 2), and a brake actuation device 265 coupled to the second component 170 of the upper arm 120 (FIG. 2). In the illustrated embodiment, the sensor 255 is a contact switch having a plunger 257 that is selectively actuated by the actuator 260 when the upper arm 120 is moved to a stored position (e.g., illustrated by the left control arm 110′ in FIG. 2). The sensor 255 is electrically connected (e.g., by a connector 259) to a control unit 300 of the mower 10 (FIG. 1). The actuator 260 is rotatable with the upper arm 120 and is configured to actuate or communicate with the sensor 255. In the illustrated embodiment, the actuator 260 is an elongated plate coupled to the upper arm 120. In other embodiments, the actuator 260 may be any other structure configured to rotate with the second component 170 and communicate the sensor 255. For example, the actuator 260 may be integrally formed on the upper arm 120. In other embodiments, the sensor 255 may be a non-contact switch such as a magnetic switch, an optical sensor, or the like. In such embodiments, the actuator 260 may communicate with the non-contact switch to communicate to the control unit 300 that the upper arm 120 is in the stored position.

The brake actuation device 265 is operable to lock the drive wheels 50 (FIG. 1). In the illustrated embodiment, the brake actuation device 265 is actuated by rotation of the second component 170 to lock the drive wheels 50 (FIG. 1). In other embodiments, the brake actuation device 265 may be an electronic brake mechanism that is actuated in response to the upper arm 120 being positioned in the stored position. The brake actuation device 265 may be coupled directly to the actuator 260 such that the brake actuation device 265 and the sensor 255 are simultaneously actuated with rotation of the actuator 260.

Returning reference to FIGS. 5 and 6A, an operator may position the control arm 110 in an operational position (the right control arm 110″ in FIG. 2) or a stored position (the left control arm 110′ in FIG. 2). In the operational position, the second component 170 of the upper arm 120 extends substantially parallel with the lower arm 115. Further, each of the first biasing member 245 and the second biasing member 250 biases the rod 240 into engagement with the first recess 190 to secure the upper arm 120 in the operational position. Turning reference to FIG. 3, when the control arm 110 is in the operational position, a user may grasp the grip 140 to manipulate the control arm 110. An operator may move the upper arm 120 forward to pivot the lower arm 115 in the fore direction thereby driving the drive wheels 50 (FIG. 1) forward. Alternatively, an operator may move the upper arm 120 rearward to pivot the lower arm 115 in the aft direction thereby driving the drive wheels 50 (FIG. 1) rearward.

As illustrated in FIGS. 5, 6B, and 7, to switch the position of the control arm 110 from the operational position to the stored position, an operator may pivot the upper arm 120 of the control arm outboard (e.g., control arm 110′ in FIG. 2). Specifically, as the upper arm 120 is pivoted outboard, the rod 240 compresses the first biasing member 245 and the second biasing member 250. Compression of the biasing members 245, 250 causes the rod 240 to move across the protrusion 197 and into engagement with the second recess 195, which secures the upper arm 120 in the stored position. The protrusion 197 may provide some resistance for the rod 240 so that the rod 240 is inhibited from moving between the recesses 190, 195 unless the control arm 110 is operator-adjusted from the operational position to the stored position. The journal bearing 263 and the rod 240 may rotate relative to each other as the upper arm 120 is moved to the stored position. Movement of the upper arm 120 to the stored position also causes the actuator 260 (FIG. 7) to actuate the sensor 255 and the brake actuation device 265. Specifically, the actuator 260 depresses the sensor 255 as the control arm 110 is pivoted from the operational position to the stored position. By actuating the sensor 255, the sensor 255 indicates to the control unit 300 of the mower 10 (FIG. 1) that the mower 10 (FIG. 1) is in the parked position. By actuating the brake actuation device 265, the brake actuation device 265 engages a pawl 270 (FIG. 8) on the drive motor 85 to lock the drive wheels 50 (FIG. 1). The indication provided by the sensor 255 and the locked drive wheels 50 (FIG. 1) allows the prime mover 20 to remain running even when in the parked position. In absence of the indication provided by the sensor 255 and the locked drive wheels 50 (FIG. 1), a typical mower would shut off the prime mover 20 to inhibit unintended use of the mower 10. By locking the drive wheels 50 (FIG. 1) and indicating that the mower 10 is in a parked position, the drive wheels 50 (FIG. 1) are prevented from moving and mower blade rotation is stopped. This feature allows an operator to pause and resume operation of the mower 10 (FIG. 1) without having to restart the prime mover 20. As such, this feature may reduce overall fuel consumption of the mower 10 (FIG. 1).

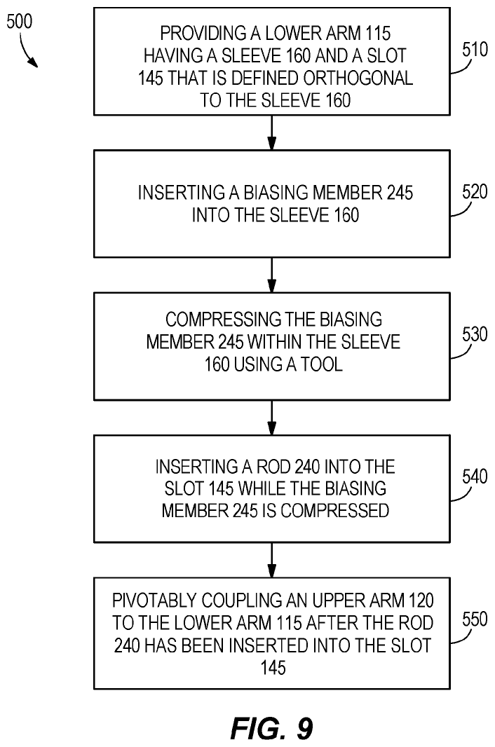

FIG. 9 illustrates an assembling process 500. The assembling process 500 is a method for assembling the steering mechanism. Although the assembling process 500 is described with reference to these steps, not all of the steps need to be performed or need to be performed in the order presented.

The assembling process 500 includes, with reference to FIGS. 5 and 9, providing the lower arm 115 having the first sleeve 155, the second sleeve 160, the first slot 145, and the second slot 150 (Step 510). The first slot 145 and the second slot 150 are defined orthogonal to the first sleeve 155 and the second sleeve 160.

The first biasing member 245 is inserted into the first sleeve 155 and the second biasing member 250 into the second sleeve 160 (Step 520). Each of the first biasing member 245 and the second biasing member 250 may be inserted such that an end of the first biasing member 245 and the second biasing member 250 extends from the first sleeve 155 and the second sleeve 160, respectively, into the first elongated slot 145. In such embodiments in which only one of the first sleeve 155 and the second sleeve 160 is provided, the lower arm 115 may be provided with just one of the first biasing member 245 and the second biasing member 250 that corresponds to the one of the first sleeve 155 and the second sleeve 160.

With continued reference to FIGS. 5 and 9, the first biasing member 245 and the second biasing member 250 are each compressed with a tool (Step 530). In the illustrated embodiment, the biasing members 245, 250 are each compressed by inserting a tool through the first slot 145. For example, the tool may be a screwdriver, a flathead screwdriver, or any other similar relatively small diameter tool. The tool may be inserted into the first elongated slot 145 over a top of the first biasing member 245 and the second biasing member 250. The tool may then be pushed in a direction away from the upper end of the lower arm 115 to compress the first biasing member 245 and the second biasing member 250. For example, the first biasing member 245 and the second biasing member 250 may be compressed such that the end of the first biasing member 245 and the second biasing member 250 does not extend into the first elongated slot 145.

The rod 240 is then inserted into the first elongated slot 145 while each of the first biasing member 245 and the second biasing member 250 is compressed (Step 540). Compressing the first biasing member 245 and the second biasing member 250 provides clearance in the first elongated slot 145 for the rod 240 to be fully inserted into the first elongated slot 145. In the illustrated embodiment, the journal bearing 263 is inserted in the recess between the yoke arms 135a, 135b and the rod 240 is inserted through the journal bearing 263 as the rod 240 is inserted into the first elongated slot 145.

The upper arm 120 is pivotably coupled to the lower arm 115 (Step 550). Specifically, the aperture 252 in the upper arm 120 may be aligned with the second slot 150 defined in the yoke arms 135a, 135b. The pivot pin 235 may then be inserted through the second slot 150 and the aperture 252 defined in the upper arm 120 to pivotably couple the upper arm 120 to the lower arm 115. Once the upper arm 120 is coupled to the lower arm 115, the first biasing member 245 and the second biasing member 250 biases the rod 240 toward the upper end of the lower arm 115 and into engagement with the cam surface 185 defined in the upper arm 120

The foregoing is a description of one embodiment of the invention and is not limiting. The invention may be embodied in any outdoor power equipment or other application in which it is desired to provide linear and angular adjustment of one component with respect to another component in a single joint. Also, as one of ordinary skill in the art will appreciate, the components of the disclosed embodiment can be reversed and interchanged.

Thus, the invention is to cover all modifications, equivalents, and alternatives falling within the spirit and scope of the invention as defined by the following claims.

What is claimed is:

1. A control arm for a lawn mower, the control arm comprising:
a lower arm having a slot defined therein;
an upper arm pivotably coupled to the lower arm, the upper arm having a cam surface defining a first recess and a second recess; and
a latch mechanism formed between the upper and lower arms to selectively secure the upper arm in an operational position or a stored position, the latch mechanism including
a rod supported and movable within the slot, and
a biasing member configured to bias the rod into engagement with the first recess to secure the upper arm in the operational position or the second recess to secure the upper arm in the stored position.

2. The control arm of claim 1, wherein the slot of the lower arm is a first slot, the lower arm further including a second slot that receives a pivot pin to pivotably couple the upper arm to the lower arm.

3. The control arm of claim 1, wherein the lower arm includes a yoke having a first yoke arm, a second yoke arm, and a recess defined between the first and second yoke arms, and wherein a portion of the upper arm is received in the recess between the first and second yoke arms.

4. The control arm of claim 3, wherein the biasing member is a first biasing member, the control arm further including a second biasing member, wherein a first sleeve is defined in the first yoke arm such that the first biasing member is received in the first sleeve of the first yoke arm, and wherein a second sleeve is defined in the second yoke arm such that the second biasing member is received in the second sleeve of the second yoke arm.

5. The control arm of claim 3, further comprising a journal bearing rotatably supported on the rod within the recess defined between the first and second yoke arms, wherein the journal bearing is positioned between the rod and the cam surface, and wherein the journal bearing and the rod are configured to rotate relative to each other when the upper arm is moved between the operational and stored positions.

6. The control arm of claim 1, wherein the upper arm further includes
a first component,
a second component, and
an adjustable coupling that couples the first component with the second component.

7. The control arm of claim 6, wherein the first component includes a grip portion configured to be grasped by an operator to manipulate the control arm, and wherein the adjustable coupling is operable to adjust the position of the grip portion relative to the operator.

8. The control arm of claim 1, further comprising a brake cable coupled to the upper arm, and wherein the brake cable is operable to lock a ground engaging element of the lawn mower when the upper arm is in the stored position.

9. The control arm of claim 1, further comprising a switch coupled to the lower arm, and wherein the switch in communication with a control unit on the lawn mower to selectively indicate to the control unit that the upper arm is in the stored position.

10. A control arm for a lawn mower having ground engaging elements, the control arm comprising:
a lower arm;
an upper arm pivotably coupled to the lower arm;
a latch mechanism formed between the upper and lower arms to selectively secure the upper arm in an operational position or a stored position;
a sensor coupled to the lower arm, the sensor in communication with a control unit on the lawn mower to selectively indicate to the control unit that the upper arm is in the stored position;
an actuator coupled to the upper arm and configured to communicate with the sensor when the upper arm is in the stored position; and
a brake actuation device coupled to the upper arm, the brake actuation device being operable to lock the ground engaging element when the upper arm is in the stored position.

11. The control arm of claim 10, wherein the brake cable is coupled to the actuator, and wherein the brake cable is configured to be actuated as the upper arm pivots toward the stored position.

12. The control arm of claim 10, wherein the latch mechanism includes
a rod supported and movable within a slot, and
a biasing member configured to bias the rod into engagement with the first recess to secure the upper arm in the operational position or with the second recess to secure the upper arm in the stored position.

13. The control arm of claim 12, wherein the lower arm includes a yoke having a first yoke arm, a second yoke arm, and a yoke recess defined between the first and second arms, and wherein a portion of the upper arm is received in the yoke recess.

14. The control arm of claim 13, wherein the biasing member is a first biasing member, the control arm further including a second biasing member, a first sleeve defined in the first yoke arm, and a second sleeve defined in the second yoke arm, each of the first biasing member and the second biasing member being received in the first yoke arm and the second yoke arm.

15. A method for assembling a control arm for a lawn mower, the method comprising:
providing a lower arm having a sleeve and a slot that is defined orthogonal to the sleeve;
inserting a biasing member into the sleeve;
compressing the biasing member within the sleeve using a tool;
inserting a rod into the slot while the biasing member is compressed; and
pivotably coupling an upper arm to the lower arm after the rod has been inserted into the slot.

16. The method of claim 15, wherein the sleeve is a first sleeve, the slot is a first slot, and the biasing member is a first biasing member, wherein providing the lower arm includes providing a second sleeve and a second slot that is defined orthogonal to the second sleeve in the lower arm, and wherein inserting the biasing member includes inserting the first biasing member into the first sleeve and inserting a second biasing member into the second sleeve.

17. The method of claim 16, wherein compressing the biasing member within the sleeve using a tool includes inserting the tool into the slot over both the first biasing member and the second biasing member and pushing the tool against a bias of both the first biasing member and the second biasing member.

18. The method of claim 16, wherein pivotably coupling the upper arm to the lower arm includes inserting a pivot pin through the second slot defined in the lower arm and through an aperture defined in the upper arm.

19. The method of claim 18, wherein pivotably coupling the upper arm to the lower arm includes providing the upper arm with a cam surface including a first recess, a second recess, and a protrusion extending between the first recess and the second recess, and wherein the method further includes releasing the compression of the biasing member such that the biasing member pushes the rod into engagement with one of the first recess and the second recess.

20. The method of claim 19, wherein inserting the rod into the slot while the biasing member is compressed includes providing a bearing mounted at a location on the rod that is configured to engage the one of the first recess and the second recess when the compression of the biasing member is released.
